(19) United States
(12) Patent Application Publication
(10) Pub. No.: US 2025/0001411 A1
(43) Pub. Date: Jan. 2, 2025

(54) METHOD FOR MANUFACTURING A BIOLOGICAL ANALYSIS CARD COMPRISING A PRETREATMENT CHAMBER PROVIDED WITH SOLID BODIES

(71) Applicant: BIOMÉRIEUX, Marcy L'Etoile (FR)

(72) Inventor: Frédéric FOUCAULT, Marcy L'Etoile (FR)

(73) Assignee: BIOMÉRIEUX, Marcy L'Etoile (FR)

(21) Appl. No.: 18/700,573

(22) PCT Filed: Oct. 10, 2022
(86) PCT No.: PCT/FR2022/000092

§ 371 Date: Apr. 11, 2024

(30) Foreign Application Priority Data
Oct. 15, 2021 (FR) FR2110970

(51) Int. Cl. B01L 3/00

(52) U.S. Cl. CPC B01L 3/502707; B01L 2200/0647; B01L 2200/12; B01L 2300/0816; B01L 2400/043

(57) ABSTRACT

A method for manufacturing a biological analysis card includes a biological sample pre-treatment chamber configured to receive a biological sample including biological components such as biological cells, said pre-treatment chamber including solid bodies configured to mechanically separate all or some of the components of the biological sample in order to make available all or some of said components of the biological sample for a biological analysis treatment, the method being characterised in that it includes a step of depositing the solid bodies in the pre-treatment chamber in the form of a solid agglomerate, said agglomerate including the solid bodies and a binder which binds the solid bodies together.

### TECHNICAL FIELD

The invention belongs to the field of biological analysis, and more particularly relates to a method for manufacturing a biological analysis card comprising at least one chamber for pretreatment of a biological sample, provided with solid bodies. The pretreatment comprises separating components of the biological sample in order to make said components of the biological sample available for a biological analysis treatment. The biological sample may be blood, for example, or another organic fluid, and the separation of the components may for example consist of isolation of the formed elements from the blood or lysis of biological cells from the biological sample.

### Technology Background

A number of methods for analysis of a biological sample may involve the need to make available components of the biological sample placed in a biological analysis card. It is then necessary to perform a step of pretreatment, or preparation, of the biological sample in a pretreatment chamber, or preparation chamber, of the biological analysis card.

For example, the analysis treatment may concern only the formed elements (erythrocytes, leukocytes and blood platelets) of a blood sample, and it is necessary to perform a pretreatment in order to separate the formed elements and the blood plasma. As another example, an immunoassay or immunological test is based on the specific binding capacity between antigens and antibodies, even using immunoglobulin, contained in plasma, which involves isolating them from a blood sample containing them. Or, in the context of a polymerase chain amplification process, more commonly referred to as PCR which stands for Polymerase Chain Reaction, the lysis of biological cells makes it possible to extract the fragments of deoxyribonucleic acid (DNA), or ribonucleic acid (RNA), which will then be amplified.

Thus, once the components of the biological sample have been made available by the pretreatment, these components are transferred to other parts of the analysis card for the implementation of the analysis treatment which makes it possible to obtain the analysis results, said analysis treatment possibly comprising several steps. Following the pretreatment, the biological sample and its components are circulated in the analysis card fluidically.

The use of solid bodies such as beads makes it possible to carry out the pretreatment mechanically. The pretreatment is carried out mechanically in the sense that it does not essentially involve chemical reactions with solid bodies. For example, lysis obtained by means of a surfactant or detergent causing the cells to burst by dissolution or destruction of the membrane is chemical lysis, not mechanical. Conversely, lysis may be obtained by mechanical means which, through physical pressure of solid bodies on the membranes of the biological cells, cause said membranes to rupture. For example, magnetic beads are used. These magnetic beads are mixed with the sample and subjected to the effect of a variable external magnetic field which causes a stirring movement of the magnetic beads in the sample, during which the contact between the magnetic beads and the biological cells causes rupture of the cell membranes. Solid bodies such as beads may be used to perform the separation of the components of the sample. For example, beads, optionally magnetic beads, are used. These beads are mixed with the sample and subjected to fluid pressure waves in order to stir them in the sample, during which the contact between the beads and the formed elements of the whole blood causes their separation.

These beads may be placed beforehand in a sample pretreatment chamber of an analysis card which is configured to receive the biological sample generally in liquid form. During the manufacture of an analysis card, beads are supplied suspended in a liquid solution, typically water, and this liquid mixture is deposited in the sample pretreatment chamber. This deposit may for example be 4 μL or 5 μL and may for example be carried out manually with a dosing pipette, or using a robot. The liquid mixture thus deposited in the pretreatment chamber is then dried. Once drying is complete, the beads are available in the sample pretreatment chamber that will receive the biological sample.

Such an approach has several drawbacks. Drying the liquid mixture requires exposure of the mixture deposit to the open air for a sufficient time to dry the deposited mixture. Drying takes time and therefore slows down the process of manufacturing the analysis card, since the analysis card cannot be closed and sealed until drying is complete, while manufacturing must be sufficiently advanced to allow the mixture to be put in place. To reduce the drying time, it is preferable to split the volume to be deposited into several small-volume deposits of mixture in the sample pretreatment chamber, at a distance from one another so that they remain separate, rather than a single deposit containing the entire volume of mixture. However, spreading out the deposit in this way requires a sufficient surface area in the pretreatment chamber, which is not compatible with the need for miniaturization and savings on material inherent in the manufacture of a consumable such as the analysis card.

The deposit of the mixture itself may be difficult. The beads tend to sediment in the mixture to be deposited. Consequently, the beads tend to settle at the bottom of the reservoir of the tool used for the deposit, especially when this tool is used intermittently, this intermittency arising from the need to dry the mixture deposits, which does not allow manufacturing continuity. This may result in heterogeneity in the deposited mixture.

It is possible to increase the concentration of beads in the mixture, in order to be able to simply deposit a smaller volume of mixture. However, too high a concentration of beads in the mixture may make handling difficult, complicating or even preventing the deposit of the mixture.

### Presentation of the Invention

The invention therefore aims to allow the manufacture of a biological analysis card comprising a sample pretreatment chamber provided with solid bodies configured to mechanically cause a separation of components of a biological sample, which is rapid and simple to implement, in particular as regards placing the solid bodies in the biological sample pretreatment chamber.

To this end, the invention proposes a method for manufacturing a biological analysis card comprising a chamber for pretreatment of a biological sample that is configured to receive a biological sample comprising biological components such as biological cells, said pretreatment chamber comprising solid bodies configured to mechanically cause a separation of all or some of the components of the biological sample in order to make all or some of said components of the biological sample available for a biological analysis treatment, the method comprising a step of depositing the solid bodies in the pretreatment chamber in the form of a solid agglomerate, said agglomerate comprising the solid bodies and a binder which binds the solid bodies together.

By introducing the manufacture and deposit of an agglomerate of solid bodies, the invention makes it possible to easily and rapidly place the solid bodies in the sample pretreatment chamber, without requiring immobilization of the analysis card during a drying period. As drying no longer takes place in the pretreatment chamber, there is no longer a requirement for sufficient space to allow the mixture to be spread out in several separate drops in order to accelerate drying, and constraints in terms of the size or shape of the pretreatment chamber may be relaxed.

The invention is advantageously supplemented by the various following features, which may be implemented alone or in their various possible combinations.

According to one feature of the invention, the binder is soluble in water.

According to one feature of the invention, the solid bodies are magnetic, and are therefore adapted to be moved by a magnetic field external to the analysis card.

According to one feature of the invention, the solid bodies are metal beads.

According to one feature of the invention, the binder contains mainly carbohydrates.

According to one feature of the invention, the agglomerate comprises at least 100 solid bodies.

According to one feature of the invention, the method comprises a preliminary step of forming the agglomerate, comprising the following steps: a) depositing a volume of mixture of solid bodies and binder on a drying surface, forming a deposit of mixture, b) drying the volume of mixture to obtain an agglomerate on the drying surface, c) removing the agglomerate from the drying surface.

According to one feature of the invention, preferably, in step a), the mixture is deposited in the form of a drop, and the volume of mixture is less than 12 μL.

According to one feature of the invention, in step c), the removal of the agglomerate from the drying surface is carried out by suction of the agglomerate.

The invention also relates to an analysis card manufactured according to the method of the invention, the biological analysis card comprising a pretreatment chamber that is configured to receive a biological sample comprising biological components such as biological cells, said pretreatment chamber (4) comprising solid bodies configured to cause a separation of all or some of the biological components of the biological sample in order to make all or some of said components of the biological sample available for a biological analysis treatment, the solid bodies in the sample pretreatment chamber being present in the form of a solid agglomerate, said agglomerate comprising the solid bodies and a binder which binds the solid bodies together.

### PRESENTATION OF FIGURES

Other features, aims and advantages of the invention will become apparent from the following description, which is purely illustrative and non-limiting, and which must be read with reference to the appended drawings, in which:

FIG. 1 shows a top view of an example of an analysis card comprising a sample pretreatment chamber, according to one possible embodiment of the invention,

FIG. 2 shows enlarged views of various phases of manufacturing and putting in place an agglomerate according to one possible embodiment of the invention,

FIG. 3 is a diagram showing steps of the method for manufacturing an analysis card according to one possible embodiment of the invention.

### DETAILED DESCRIPTION

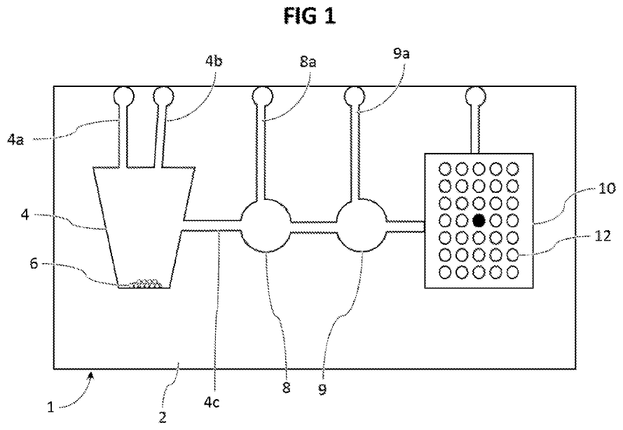

FIG. 1 shows an example of a biological analysis card configured to receive a biological sample comprising biological components such as biological cells. The biological sample is generally liquid, being placed in solution beforehand if necessary. A biological cell includes a plasma membrane delimiting its internal environment. A biological cell is for example a cell of a complex organism, a bacterium, a virus, a yeast, etc.

Such an analysis card is a consumable, that is to say it is intended to be used only for a biological analysis, and to be then thrown away. A biological analysis corresponds to any method comprising a test for qualitative (measurement of the presence) or quantitative (determination of the concentration) assay of molecules in a sample of biological material, such as for example a test to detect pathogenic cells, a test for in vitro diagnosis, an immunological test, a screening test, etc. Treatment means the steps implemented during the biological analysis on components of the biological sample, which make it possible to obtain the results of the biological analysis.

The biological sample may be in liquid form or in the form of a fluid and comprising biological components such as biological cells, and may for example be a body fluid such as blood, lymph, cerebrospinal fluid, amniotic fluid, urine, mucus, etc., or tissue extracts or ground tissue in suspension, such as for example a nasopharyngeal or oral sample, etc.

The analysis card 1 generally comprises a structure 2, generally made of plastic, which forms a matrix in which the other elements of the analysis card 1 are formed or inserted. The structure 2 may advantageously comprise at least two soft or flexible plastic films, preferably transparent, sealed to one another except in the areas accommodating the other elements of the analysis card 1 between the two films. An opaque sheet may be added, preferably made of aluminum attached to one of the outer faces of one of the plastic films.

These elements include in particular a sample pretreatment chamber 4 configured to receive the biological sample comprising biological cells. In this example, the sample pretreatment chamber 4 takes the form of a space between the films of the structure 2. The sample pretreatment chamber 4 may in particular be delimited by hermetically sealed areas of the structure 2. The sample pretreatment chamber 4 may be associated with supply channels 4a, 4b for supplying the biological sample and/or other liquid, and with a discharge channel 4c configured to discharge the biological cells from the sample pretreatment chamber 4 once the biological cells have been separated. These channels 4a, 4b, 4c open into the sample pretreatment chamber 4 at discontinuities in the hermetically sealed areas of the structure 2.

The sample pretreatment chamber 4 comprises an agglomerate 6 of solid bodies and binder. An agglomerate 6 is a solid mass of solid bodies bound together by a binder. The agglomerate is typically rigid or hard, but may be soft or ductile, for example with a gelatinous overall consistency, like a gel. In all cases, the agglomerate 6 is non-liquid, and is preferably dry. The agglomerate 6 is solid and may therefore be handled, and in particular be suspended for at least several seconds, for example by suction. The binder binds the solid bodies together, and therefore ensures the cohesion of the agglomerate 6. Typically, the agglomerate 6 comprises at least 100 solid bodies, and preferably at least 1000 solid bodies. The solid bodies preferably have the same size, typically with a diameter of less than or equal to 10 μm and more preferably less than 3 μm. Also preferably, the solid bodies have a diameter of greater than or equal to 0.01 μm, and more preferably greater than or equal to 0.2 μm.

The solid bodies are configured to mechanically cause a separation of all or some of the components of the biological sample in order to make said components of the biological sample available for a biological analysis treatment, once the solid bodies are released from the agglomerate 6 and set in motion in the presence of the biological sample. Advantageously, the solid bodies are magnetic, and are therefore adapted to be moved by an external magnetic field. The solid bodies are then made of a magnetic material. Magnetic material means a material which is magnetized or which, under the effect of an external magnetic field, acquires magnetization. This is particularly the case of ferromagnetic or paramagnetic materials, and typically the case of iron or certain iron oxides. A solid body is said to be made of a magnetic material when it contains mainly a magnetic material, for example an alloy comprising mainly a magnetic material. Preferably, the solid bodies are metal. The solid bodies may advantageously have the shape of a solid of revolution, and preferably may be round, thus forming magnetic beads. Preferably, the solid bodies are magnetic metal beads. However, the solid bodies may also be non-metal and non-magnetic, and may for example be made of silica, and more particularly be silica beads.

The binder is soluble in the biological sample such that when the biological sample is brought into the pretreatment chamber 4 where the agglomerate 6 is located, for example via the supply channels 4a, 4b, the binder dissolves and releases the solid bodies in the biological sample. The solid bodies are then set in relative motion with respect to the biological cells of the biological sample, for example by virtue of a variable external magnetic field, easily obtained by controlling the electrical power supply of a component such as a coil, or by using fluid pressure waves, for example by pressing on the wall of the pretreatment chamber 4. When the solid bodies are intended to bring about lysis, the moving solid bodies exert physical pressure on the membranes of the biological cells, and cause the rupture of said membranes, and therefore the lysis of the biological cells. When the solid bodies are intended to bring about separation of the formed elements of the blood, the contact between the solid bodies and the formed elements of the blood during stirring causes the separation of said formed elements. The nature of the pretreatment obtained may depend on the type of biological sample, the size of the solid bodies, and the intensity with which they are set in motion.

In general, it is sufficient for the binder to be soluble in water for the binder to be soluble in the biological sample. The agglomerate 6 therefore preferably disintegrates in the presence of liquid water. The binder is selected to ensure binding of the solid bodies in the agglomerate 6 before its dissolution while limiting biological or chemical interference with the biological cells which could be detrimental to the planned biological analysis following dissolution. The binder may for example contain mainly carbohydrates, for example sugar, notably sucrose, or contain soluble polymers such as dextran, or polylactic acid (PLA). Other additives may be present, for example albumin such as bovine serum albumin or BSA, emulsifiers or surfactants such as polysorbates (polyoxyethylene sorbitan fatty acid esters).

The analysis card 1 may include other elements in fluidic communication with one another. For example, the discharge channel 4c may connect the sample pretreatment chamber 4 to additional chambers 8, 9 allowing various treatments to be carried out on the components of the biological sample. For example, a first additional chamber 8 may be a rinsing chamber and/or a chamber in which the solid bodies are magnetically retained in order to isolate the parts of the biological sample which will not be useful in the rest of the treatment. The solid bodies may be kept in such an additional chamber 8 by applying a magnetic field thereto, in particular a permanent magnetic field, for example by means of a magnet placed facing this additional chamber 8. Another additional chamber 9 may make it possible to implement a biological or chemical process, such as for example amplification in the context of a PCR process. Other elements such as an analysis plate 10 may also be present, this having for example wells 12 provided with reagents, the interaction of which with the treated parts of the biological cells forms the basis of the biological analysis. It is for example possible to see whether or not a visible change occurs in each of the wells 12 to obtain the results of the analysis. Of course, the analysis card 1 described above is merely an example, and its composition and structure may vary greatly depending on the analyses to be carried out, as well as on the design and manufacturing constraints and choices. The only requirement is that the biological analysis card include a sample pretreatment chamber 4 configured to receive a biological sample, provided with solid bodies.

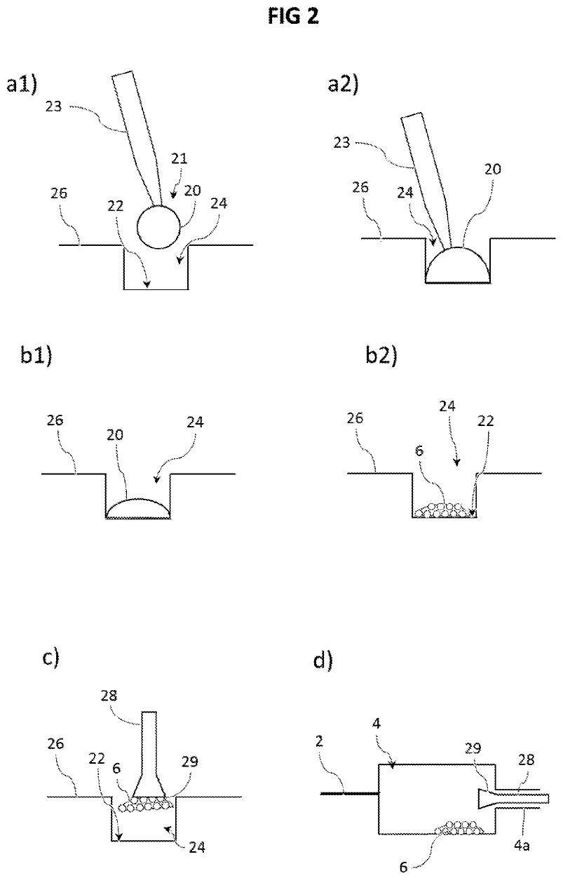

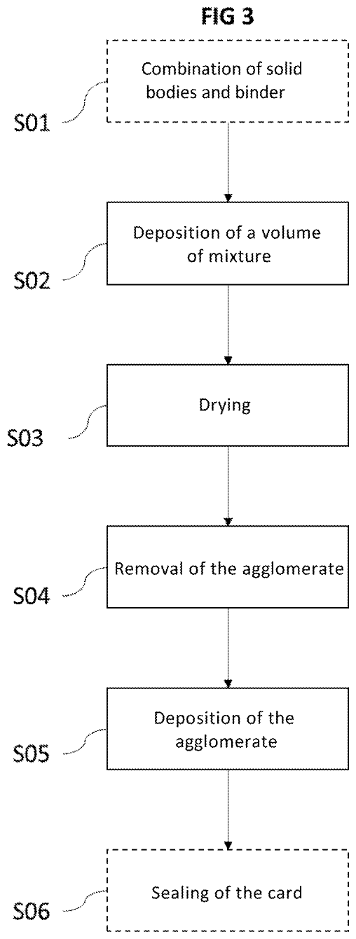

With reference to FIG. 2 and FIG. 3, a method for manufacturing a biological analysis card 1 according to the invention will now be described. A preliminary step S01 may include combining solid bodies and binder to obtain a liquid mixture of solid bodies and binder, if the mixture is not already prepared. Typically, the magnetic bodies are suspended in a liquid solution, typically an aqueous solution, that is to say with water as solvent, with one or more binders capable of causing the binding of magnetic bodies upon drying of the mixture while limiting biological or chemical interference detrimental to the planned biological analysis. As mentioned above, a binder may be a sugar, in particular sucrose. Other additives may be added, for example albumin such as bovine serum albumin or BSA, emulsifiers or surfactants such as polysorbates (polyoxyethylene sorbitan fatty acid esters).

For the sake of simplification, the manufacture of a single agglomerate 6 is illustrated and described, but it is understood that the manufacture of several agglomerates 6 may be carried out in parallel. As shown in phases a1) and a2) of FIG. 2, a volume 20 of mixture of solid bodies and binder is then deposited (step S02) on a drying surface 22. The volume 20 of mixture deposited on the drying surface 22 depends on the number of solid bodies it is desired to obtain in the agglomerate, and on the concentration of solid bodies in the mixture. For example, the volume 20 of mixture may be between 1 μL and 12 μL, and preferably between 2 μL and 6 μL. The drying surface 22 may be any surface allowing the mixture to dry. Advantageously, the drying surface 22 may be the bottom of a well 24, for example in a plate 26 comprising several dozen wells 24. These wells 24 are thus preferably distributed regularly over the surface of the plate 26, forming a grid facilitating automation of the deposition of the volumes 20 of mixture in their respective wells 24. The use of a well 24 makes it possible to limit any spreading of the volume 20 of mixture on the drying surface 22, and to ensure exact positioning of the volume 20 of mixture on the drying surface 22, which is particularly advantageous in the case where all or part of the process is automated.

In this example, during a first phase a1), a drop 21 of mixture is formed at the end of a depositing instrument 23, which is for example a pipette which may be carried by a robotic arm. This drop 21 is then deposited in the bottom of the well 24 forming the drying surface 22, and the depositing instrument 23 is removed. To prevent the agglomerate sticking to the drying surface 22, the drying surface may be hydrophobic. For example, it is possible for the drying surface to have a non-stick material such as polytetrafluoroethylene, or PTFE. It is also possible to coat the drying surface 22 with a hydrophobic product such as an oil or a wax.

Following these phases a1) and a2) of the deposition step S02, a volume 20 of mixture of solid bodies and binder is thus present on the drying surface 22. This volume 20 of mixture is then dried (step S03). Drying means a process of solidification of the volume 20 of mixture, which preferably consists of dehydration but may possibly consist of crosslinking. Drying may include exposure to the open air of the volume 20 of mixture of solid bodies and binder until the solution of the mixture evaporates. It is possible to heat the air, for example above 30° C., to speed up drying. It is also possible to control the atmosphere to which the volume 20 of mixture is exposed, for example by providing ventilation or with a partial or total vacuum. Phase b1) of FIG. 2 shows a volume 20 of mixture drying at the bottom of a well 24 forming the drying surface 22. Advantageously, drying may be carried out in an oven or a desiccator.

During drying, the evaporation of the solution of the mixture causes solidification of the binder, which will trap the solid bodies and thus form the agglomerate 6. For example in the case of sugar, drying causes crystallization of the sugar which solidifies, trapping the solid bodies. On completion of drying, as shown in phase b2) of FIG. 2, an agglomerate 6 of solid bodies bound together by the binder is found on the drying surface 22.

The agglomerate is then removed from the drying surface (step S04). The removal of the agglomerate from the drying surface 22 may advantageously be carried out by suction of the agglomerate 6, for example by a suction cup 29. In the example illustrated by phase c) of FIG. 2, a robotic arm 28 carrying a suction cup 29 produces aspiration which sticks the mixture 6 to the suction cup 29 by suction. However, it is possible to remove the agglomerate 6 in another way, such as by simply picking it up with tongs.

To facilitate the removal of the agglomerate 6, in particular when said removal is carried out by aspiration or suction, it is possible to implement mechanical detachment of the agglomerate 6 in order to disengage it, even partially, from the drying surface 22. For example, vibration may be applied to the drying surface 22, or a detachment tool, for example a blade, may be applied against the agglomerate 6, in particular at the interface between the agglomerate 6 and the drying surface 22.

The agglomerate 6 is then deposited (step S05) in the sample pretreatment chamber 4. Advantageously, the pretreatment chamber 4 is already formed at this stage. There is in fact no need to leave the pretreatment chamber 4 open (for example with one wall missing) because it is no longer necessary to dry the mixture therein in the open air. The agglomerate 6 may for example be brought in via a supply channel 4a, 4b. Deposition may be carried out by stopping the suction when the agglomerate 6 is conveyed by suction. In the example illustrated by phase d) of FIG. 2, the robotic arm 28 is inserted in a supply channel 4a until the suction cup 29 which it carries enters the sample pretreatment chamber 4 in which it is desired to deposit the agglomerate 6, and the suction of the robotic arm 28 is stopped. The robotic arm 28 and its suction cup 29 may then be withdrawn, leaving the agglomerate 6 in place in the sample pretreatment chamber 4.

It is then possible to seal the analysis card 1 (step S06), for example by blocking or closing the supply channels 4a, 4b. If the sample pretreatment chamber 4 has been left open, for example to allow the agglomerate to be introduced through a missing wall of said sample pretreatment chamber 4, the pretreatment chamber 4 may then be closed by putting in place the missing wall, for example a film forming part of the structure 2. Since no drying is necessary after the solid bodies, in the form of an agglomerate 6, have been placed in the sample pretreatment chamber 4, sealing of the analysis card 1 may immediately follow the insertion of the agglomerate 6. The analysis card 1 is then ready to be used to carry out a biological analysis.

The invention is not limited to the embodiment described and shown in the appended figures. Modifications are possible, in particular from the point of view of the nature of the various technical features or of substitution of technical equivalents, without however departing from the scope of protection of the invention.

1. A method for manufacturing a biological analysis card comprising a chamber for pretreatment of a biological sample that is configured to receive a biological sample comprising biological components such as biological cells, said pretreatment chamber comprising solid bodies configured to mechanically cause a separation of all or some of the components of the biological sample in order to make all or some of said components of the biological sample available for a biological analysis treatment, wherein the method comprises a step of depositing the solid bodies in the pretreatment chamber in the form of a solid agglomerate, said agglomerate comprising the solid bodies and a binder which binds the solid bodies together.

2. The method as claimed in claim 1, wherein the binder is soluble in water.

3. The method as claimed in claim 1, wherein the solid bodies are magnetic, and are therefore adapted to be moved by a magnetic field external to the analysis card.

4. The method as claimed in claim 1, wherein the solid bodies are metal beads.

5. The method as claimed in claim 1, wherein the binder contains mainly carbohydrates.

6. The method as claimed in claim 1, wherein the agglomerate comprises at least 100 solid bodies.

7. The method as claimed in claim 1, said method comprising a preliminary step of forming the agglomerate, comprising the following steps:
a) depositing a volume of mixture of solid bodies and binder on a drying surface, forming a deposit of mixture,
b) drying the volume on the drying surface,
c) removing the agglomerate from the drying surface.

8. The method as claimed in claim 7, wherein in step a), the mixture is deposited in the form of a drop, and the volume of mixture is less than 12 μL.

9. The method as claimed in claim 7, wherein in step c), the removal of the agglomerate from the drying surface is carried out by suction of the agglomerate.

10. A biological analysis card comprising a pretreatment chamber that is configured to receive a biological sample comprising biological components such as biological cells, said pretreatment chamber comprising solid bodies configured to cause a separation of all or some of the biological components of the biological sample in order to make all or some of said components of the biological sample available for a biological analysis treatment,
wherein the solid bodies in the sample pretreatment chamber are present in the form of a solid agglomerate, said agglomerate comprising the solid bodies and a binder which binds the solid bodies together.
